(19) United States
(12) Patent Application Publication
(10) Pub. No.: US 2002/0082882 A1
(43) Pub. Date: Jun. 27, 2002

(54) Computerized method of evaluating and shaping a business proposal

(75) Inventors: Thad R. Perry, New Albany, OH (US); Michael F. Ballanco, Somerset, NJ (US); Christopher F. Garber, Clark, NJ (US); Karim A. Homsany, Sparta, NJ (US); Mary P. Kroeten, Tampa, FL (US); Gregory A. Rowe, Somerset, NJ (US)

Correspondence Address: BRINKS HOFER GILSON & LIONE, P.O. BOX 10395, CHICAGO, IL, 60610, US

(73) Assignee: Accenture LLP

(21) Appl. No.: 09/746,611

(22) Filed: Dec. 21, 2000

(51) Int. Cl. G06F 17/60

(52) U.S. Cl. 705/7; 705/1

(57) ABSTRACT

A method for evaluating a business proposal, and a computerized system for evaluating and pricing the proposal. An evaluation for a service is generated by gathering information on the customer, the service-provider's cost experience in providing services to this and to other customers, and the estimated cost of providing this particular service. The method also may be used to calculate the benefit to the provider of providing and to customer of receiving a particular service.

### FIELD OF THE INVENTION

The present invention is directed to a system and method for automatically evaluating a business proposal. In a particular application of this invention, a business proposal is evaluated in light of the relationship between the parties, and a computerized process is used to structure the proposal.

### BACKGROUND OF THE INVENTION

In traditional buyer/seller relationships, a buyer chooses from among many sellers. A buyer bases his choice on a number of factors, most of them concerned with the usual factors involved in a competitive situation: price, availability, quality, delivery and the like. The seller likewise may base business actions and price on knowledge of the situation and general business factors within his or her knowledge. For instance, past experience with buyers, or with the market generally, may guide a seller as to which markets and which customers to pursue. While never easy, the situation is usually manageable for manufacturers of goods. Providers of services have a harder challenge, in that each service, as well as each customer, may be unique. It is not trivial to gather information concerning prior experience with a particular customer, or even with a certain application of a service.

Moreover, in today's business world, the competitive situation may change very rapidly. Changes may include new technologies, new competitors, and new customers and opportunities. As a result of a rapidly changing climate, it may be difficult for a service-provider to accurately assess the climate in a given business situation. This is particularly the case when a service provider and a customer face the situation not as direct competitors, but rather as partners. Neither the service provider nor the customer may calculate with great certainty the outcome of their venture. An example would be the situation in which a retailer partners with a marketing consultant or an information technology consultant to venture into a new market or to apply a new technology. As discussed above, neither partner may have an accurate grasp on the risk or the opportunity of the situation. What is needed is a relatively rapid method to gather information, to assess the opportunities and risks of a business deal, and to guide the partners, or a buyer and a seller, in their actions.

### BRIEF SUMMARY OF THE INVENTION

The present invention meets this need through a computerized system and method for gathering information and evaluating a business proposal or deal. One aspect of the invention is a computerized system for gathering information on the risks and rewards of a particular business deal. In one embodiment of the invention, a provider gathers information on a particular market or on a particular potential customer. The information may include the proposed deal, the customer, the experience of the provider with the customer, and the experience the provider has had with this and other customers on this type of business deal.

Another aspect of the invention is a method for evaluating and structuring such a deal or proposal. The method includes the steps of gathering and using information concerning a buyer or a seller, the customer or customers, and the nature of the business, the goods or the service to be bought or sold. Such information is available in many places, including publicly available sources, such as the Internet, commercial electronic databases, the government, or proprietary databases of information. In one aspect of the invention, a user uses this information to evaluate the proposal after a computer gathers and displays the information.

In another embodiment, the information, especially financial information, is input into a computer, along with one or more proposed structures for the proposal. The computer then calculates an advantage to the proposer of going forward with the proposal. Advantages include, but are not limited to, a net present value of an investment, a revenue stream to either the proposer or the customer, and a future opportunity for at least one of the parties. Structures for the proposal may include any form of business entity or enterprise.

Information on a customer, even a present customer of the service provider, may not be readily available. Information that would be useful in these circumstances includes the experience of the provider in providing this type of service, the experience the provider has had with this customer, and any differences from the present proposal or deal. Such information is gathered from at least one database, and if the data is in more than one database, a method is provided to either gather or centralize the data for use. In one embodiment, the information is used to calculate a cost of providing a service to this customer. Using this information, a price is then calculated which matches the risks to the provider with commensurate rewards for this particular business deal.

The advantage of the invention is that a number of deals or proposals may be evaluated quickly. In addition, the deals or proposals may be examined from several viewpoints, or structures, to determine whether any of them may be advantageous to one party or another. Rather than having to gather all data manually, a computerized system desirably has much of the pertinent information on hand. Periodic updates of information on the most likely partners, deals, or industries would make proposal evaluating or “deal shaping” much easier and faster.

### BRIEF DESCRIPTION OF SEVERAL VIEWS OF THE DRAWINGS

FIG. 1 is a block diagram of information flow in a process to evaluate a deal.

FIG. 2 is a block diagram of specific elements of a previous deal that are pertinent to evaluating and shaping a new proposed deal.

FIG. 3 is a block diagram of components that may be used in structuring a business deal in order to evaluate its potential.

FIG. 4 is a block diagram of information sources important for the deal coaching aspects of evaluating a business deal.

FIG. 5 is a block diagram of general information sources for a portal wide advanced search for information.

FIG. 6 is a block diagram of a logic model for the proposal evaluator and shaper of the present invention.

FIG. 7 is a block diagram of the use of proprietary information from a customer's point of view, in providing information for use.

FIG. 8 is a block diagram of the use of proprietary information by a computerized deal shaper and evaluator by a proposal maker in structuring and evaluating a proposal.

FIG. 9 is a block diagram of a questionnaire form to be used by a computerized system according to the present invention.

FIG. 10 is a block diagram of a method of shaping and evaluating a proposal according to the present invention.

FIG. 11 is an embodiment of a graphical user interface for entering inputs into a computer or for receiving outputs from a computer.

### DETAILED DESCRIPTION OF PRESENTLY PREFERRED EMBODIMENTS OF THE INVENTION

In one embodiment of the invention, a computerized process is used to evaluate a business proposal. The process may be used when the proposal involves providing a service to a customer or potential customer. The advantages of the process are two-fold. The evaluation tool may be used by the service provider in order to evaluate a plurality of business deals and evaluate which deals are most profitable or most advantageous for the service provider. The other advantage comes into play for the purchaser or user of the service, in that the tool may be used to show the purchaser or user the advantages of the proposal. In addition, there may be more than one way to structure a deal. The tool allows the rapid evaluation of several ways of structuring a business deal so as to provide options for the provider and for the customer as to how to best structure the deal.

In addition to the obvious advantage of rapid evaluations and ranking by profitability, the deal shaper may be used to show the customer how the deal will accrue to the customer's benefit. That is, by purchasing the service or entering into the deal, the customer may benefit in some concrete way, such as by increased revenues or profits. The deal shaper may be used to calculate the increase in value to the customer, and thus show the customer not only how to benefit from the deal, but also how to pay for the service provided. This has obvious advantages for both parties.

Such a process may encourage the customer to accept the proposal, because the customer may now understand how to pay for the service. The customer may also gain insights in how to at least break-even from undertaking the proposal, and if the circumstances are favorable, how much profit to expect from entering into the deal. In another embodiment, a computer is used to gather information and a user evaluates the information, ranks the deal by profitability, and calculates any increase in value to a customer or to a proposer.

Gathering information is the first part of the process, as shown in FIG. 1. Knowledge may be available from a number of sources, some more readily available than others. A deal-shaping process 10 may utilize knowledge from search results 20, from elements of the proposal, from deal coaching 30, or ways to structure the deal. Inputs into the process may include general business information, such as newspaper and magazine articles and latest thinking 40 expressed in various media. A portal wide advanced search 50, such as an Internet search, may also provide inputs into the process. Company policies 60 may also form important considerations, limitations, or guidance during the process.

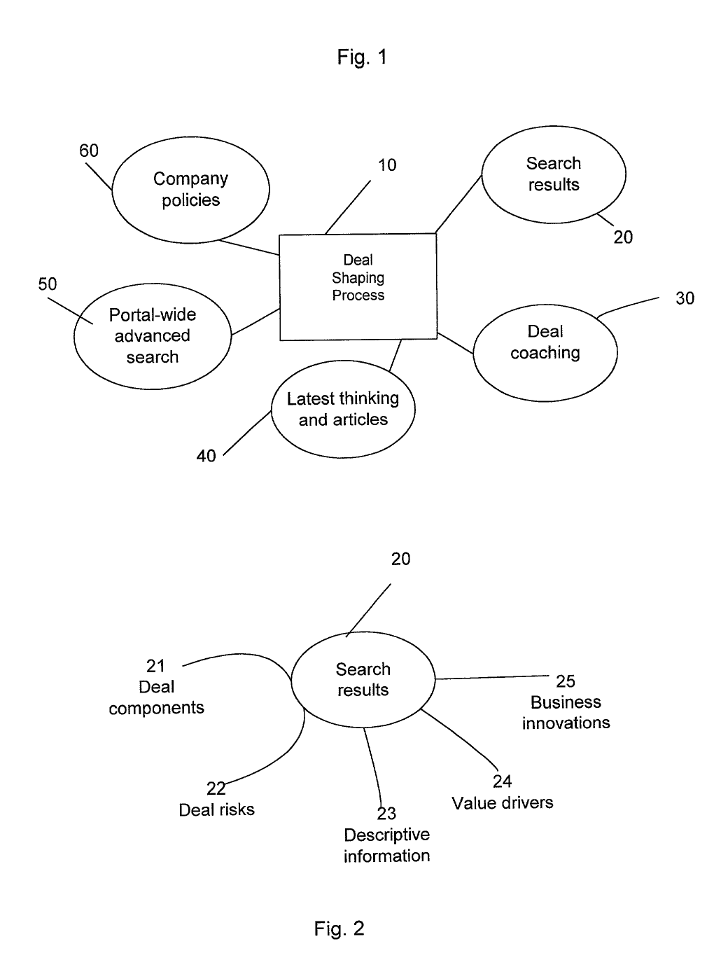

The most important information will likely be that information close to the provider of services and the customer. FIG. 2 lists some of the more important information sought in an initial search 20 for deals that are similar to the one that is being proposed. Information essential to making and evaluating a proposal will include deal components of the proposal 21, risks of the proposal 22, any descriptive information such as business issues addressed and solutions proposed 23, how the value of the proposal is driven 24, and any business innovation 25 involved that would enhance the overall value of the proposal.

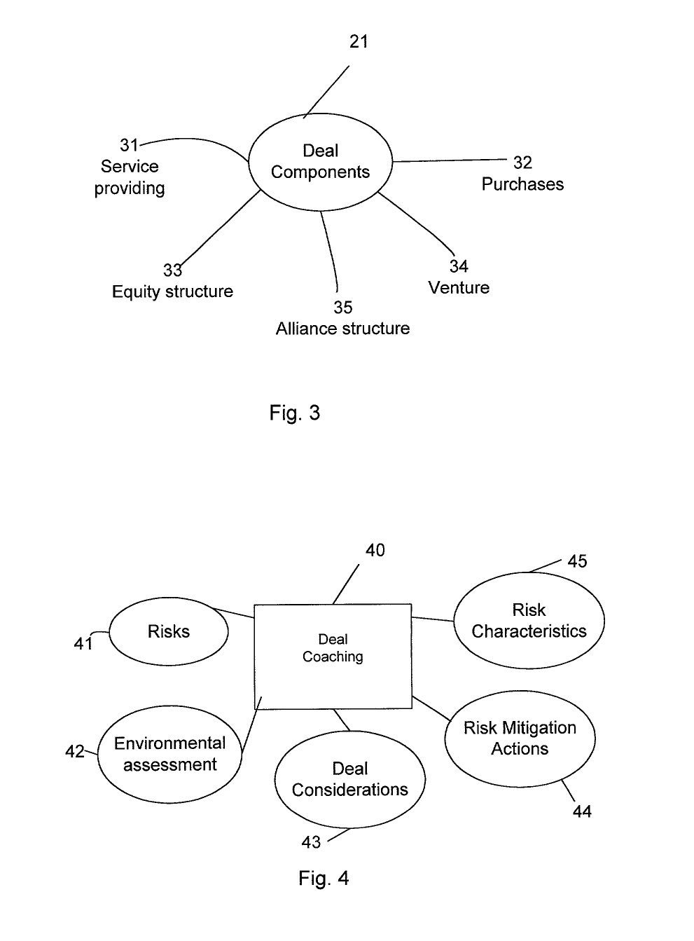

FIG. 3 depicts some of the deal components 21 available. If the proposal is one where services 31 are offered, they may be paid for in a traditional manner, or there may be a form of success sharing in the proposal. Services may include, but are not limited to, accounting services, consulting services, customer service, data processing, engineering, design and construction services, development services, educational services, financial and insurance services, governmental services, information technology services, management consulting, and sales services.

If the proposal is one for a business venture, it may take on one of many forms, an equity venture 33, a separate or jointly owned venture 34, or another form of alliance 35. A service agreement 31 may also take the form of an outsourcing of a business, a good or a service. An equity venture 33, a separate or jointly-owned venture 34 or alliance 35 may be a merger, or in some circumstances, could be an acquisition. Therefore, an entire range of business proposals may be evaluated in this embodiment. Those skilled in business practice will recognize that some proposals must be evaluated in different ways to make business sense.

Options included in shaping of a deal or proposal also include ventures in which one party outsources at least one function, such as information technology or distribution. One party may design, build or run a business or a part thereof for another. Partners may agree to other ventures as well as the one that begins their business relationship. One part of any proposal that includes joint ownership, or mergers or acquisitions, may include some form of asset creation. Aside from the balance-sheet value of the asset, such an asset may also be useful in shaping and closing future business ventures or service providing business deals. An example would be when an alliance results in a “preferred implementor” agreement which can be leveraged to sell future services deals.

Additional elements of deal components include revenue drivers. In other words, a person or business issuing a business proposal seeks revenue. This may mean different things to the different parties proposing or evaluating a proposal. To a service provider, it may mean opportunities to provide more services, if the service is provided on a per-hour or per-unit basis. If a fixed-price contract is involved, it may mean the opportunity to accomplish the job with fewer resources (that can then be applied elsewhere) or the chance to provide more services to the venture, or from opportunities derived through the venture. There may also be other types of revenues, such as incentives, or portions of profits, or in the other direction, penalties for failure to achieve certain levels of performance or sales.

Risks of a proposal could include the likelihood of continuity of clientele, the business sector, the market, market share, sales volume and growth, of these factors, and a host of others. Risks could certainly include any business risks, such as loss of customers or market share, any legal liabilities, including but not limited to the potential for environmental or remediation liability, products liability, employment liabilities or other actions. Risks may also include any likelihood of innovations that will obsolete a particular product, business, or strategy.

Of course, the opposite side of a risk is the opportunity to achieve a specific business goal. Any of the above “risks” may turn out badly for an enterprise if, for example, customers are not retained or sales goals are not met. On the other hand, if employees are motivated and goals are exceeded, then what was a “risk” becomes an opportunity to improve and grow the business. This will hold true for any of the above factors, and the same will hold true for many other factors, such as operations costs, product development pace and costs, distribution channels and costs, and the like. The value of the proposal may be driven by a combination of the perceived risks and opportunities of the deal, including some of the ones mentioned. The value should therefore be considered in view of the specific business issues and opportunities to be addressed, the solutions to be implemented and other descriptive data elements.

Under any circumstances, only some of the above factors, and perhaps some others, will be most pertinent in evaluating the proposal. A key challenge is the ability to tie the proposal to specific elements of value that will be received by the customer or business partner if the proposal is accepted. In some circumstances, market potential may be most important. In other circumstances, established financial metrics may be the only thing that matters. As is known to those skilled in the art, financial metrics may include cost accounting or financial accounting measures, and may include return on assets, asset turnover or asset turnover ratio, inventory or inventory turns, return on investment, earnings per share, growth of any of these metrics, and so forth.

Business innovation that may help in evaluating a proposal or may help in shaping a proposal may include the implementation of new technologies or new capabilities, such as new products or new services. There may be better ways to approach tasks or jobs, as by using an innovative approach, bypassing obstacles in a traditional method of doing business, or resolving difficulties in operations. There may be new markets for old products or for new products, and the opportunity or the risk may lie in creating those markets, or conversely, failing to recognize or realize the opportunity. The pace of modem life is fast and increasing, and there may be value in making best use of one's own time or that of a customer. Value may be added by shortening lines of communication, improving the scope or span of knowledge, or devising new paradigms to explain a technology, a market or a behavior.

The risks of the proposal must be evaluated in order for the parties to understand their liabilities in undertaking a given proposal. The risks may also be evaluated in different ways for the different parties to a proposal. For instance, in a services agreement, the service provider's losses could be increased by the other party's failure to pay. The other party, in such an arrangement, could stand to lose the entire amount invested in whatever form the venture takes. Steps may be taken to limit losses. Contractual arrangements may provide for limits; some form of insurance may be provided; or the agreement may provide for profit-and-loss sharing.

Of course, the best way for the proposer to avoid risks and actual losses is to have a thorough understanding of the proposal and how it will generate an adequate revenue stream. This requires an understanding of the cost drivers and revenue drivers for the project, how the fixed costs will be covered and who will cover them, how the proposal is priced, which markets will be served, how and where they will be served, whether the proposal anticipates a competitive advantage, and the like. In one sense, gathering sufficient satisfactory knowledge of the positive aspects of the proposal may minimize the risks of the project. Thus, evaluation of the risks brings us back to the task of gathering information on the opportunity at hand, as shown in FIG. 2. Ideally, this would include all the possible revenue and cost streams, the chances of increased or decreased revenue and profits based on future events, and the like. It may also include pinpointing specific markets or even customers that would enhance the revenue from the venture, or whose absence would doom the venture.

Another input into the evaluation may be what FIG. 2 refers to as value drivers. Of course, “value to the customer” might refer to the value of the goods or services provided, or to a net present value of an ongoing business. However, in the context of evaluating a proposal, a value driver might better be characterized as a circumstance or arrangement that enhances the value of the proposal to the prospective venturers.

Valve drivers may include, but are not limited to, anything that will increase revenue, reduce costs, or reduce assets necessary for a business. It is desirable to reduce operations costs, maintenance costs, distribution and development costs, customer service costs, service delivery costs, manufacturing costs, and so on. It is also desirable to increase sales, market share, sales growth, number of customers and amount of sales per customer and sales per transaction. It is desirable to create innovative new products that find market acceptance, and to create those products in ever-shorter development cycles. It is desirable to find new channels of distribution that decrease the time to market as well as distribution costs.

Business innovations should also be considered as part of a proposal. One of the advantages to be gained from a thorough search is information on other ways of doing business, on other value or revenue drivers that could be used, on related opportunities that could be brought into the proposal, or of risks that may have arisen, or of risks that have proven unfounded. One embodiment includes a thorough search for these types of information.

Another embodiment uses what might be described as “deal coaching,” in FIG. 4, in order to make a proposal as attractive and as realistic as possible. In order to “coach” or enhance a particular proposal, attention should be focused on the risks 41, the environmental assessments 42 and other considerations 43. Risks may include any likelihood of failure to attain or retain a revenue stream, capture or retain customers, and the like. That is, risks may include any likelihood that the venture, in whatever form or for whatever reason, will falter or fail to achieve its goals. Along with risks you risk characteristics 45 and suggested mitigation actions 44 that are available to improve the shape and likelihood of success for the proposal.

An environmental assessment, in a business sense, refers to the present-day situation as regards the interest rates, the market situation for the goods or service that the proposed enterprise will deal in, competition, regulation and government, taxation, import/export/currency controls, and the like as well as the state of the relationship between the parties and the past history of that relationship for the business entities involved in the deal. Other deal considerations may include values or metric that suggest or indicate business performance. Profitability is one such measure, on a “big picture” basis.

Closer looks or considerations may include but not be limited to, costs, manufacturing costs, maintenance, development, or delivery costs, costs of quality, costs of customer service or customer management, and the like. Depending on the level of deal consideration desired, questions may be asked or answered on very low-level details. These may include, but are not limited to, unit manufacturing cost, unit overhead cost, accuracy per transaction, cycle time per unit or per transaction, cost per transaction, number of units or number of transactions, assets per transaction, utilization factors, idle time, and the like. In one embodiment, these detailed considerations are left for later stages of deal shaping or deal evaluation.

The utility of a deal coaching embodiment may lie in asking and answering “what if” types of questions. Rather than merely taking the present situation as a given, it may be desirable to examine constraints and limitations. Knowing which constraints and limitations are the limiting ones in a business model may lead to an assessment of which ones could be changed. This change might be applicable to the business environment, to the risks of the particular proposal, or to other considerations of the deal. In a sense, this embodiment may be another way to examine revenue drivers. While it may be difficult to change constraints, it may be useful to know which constraints are the important ones in managing risks, in structuring a proposal, and in adding value.

A computerized search of relevant company policies 60 is one method of evaluating a business proposal. Knowing which deal attributes cannot be combined or proposed under certain conditions due to legal or financial constraint as expressed in company policies may lead to a proposal with a higher likelihood of success.

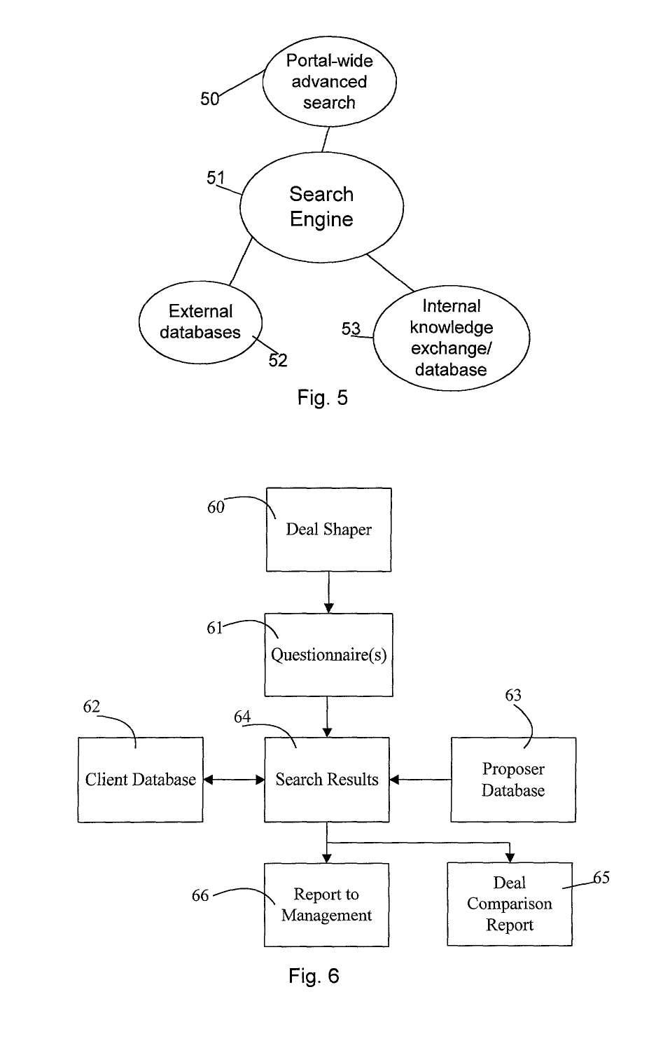

A computerized search, as shown in FIG. 5, is one method of evaluating a business proposal. A portal wide advanced search 50 is desirably accomplished using a search engine 51 or more than one search engine. The databases 52 to be covered may include those that are available generally, such as the Internet, or external, subscriber-based databases, such as Dialog®. Databases covered may also proprietary databases, such as an internal knowledge exchange or database 53, proprietary to the person or entity making a proposal, or to a person or entity evaluating a proposal. Desirable elements of the database may include general business information, but may also include information specific to a given potential customer or to a particular type of deal. One embodiment of an institutional memory useful as a database is a customer relationship repository, wherein resides a substantial portion of data concerning past dealings with a customer or a client.

In other words, in shaping and evaluating a proposal for a particular customer or entity, it will be preferable to have specific information on past dealings with this particular customer or entity, as well as this type of proposal. Such information is highly desirable, but is often very difficult to gather and use. A troublesome point may arise if the person or entity making a proposal may possess the desired information, but is not aware of the information; or if the information is not in a usable form. In one embodiment, this data is gathered and stored in a proprietary database as shown in FIG. 5. This embodiment is most desirably applied to a large provider of services, such as a consulting firm, an information technology services provider, or a management consulting services provider. It is most desirable in these situations for the very reasons mentioned above: these types of entities may indeed have the specific knowledge needed to shape and evaluate a proposal for a customer, but not in a usable form.

In one embodiment, a computer system provides for an institutional memory by gathering the desirable information and storing it in an accessible database. The information is in a form useful to persons desiring to propose further sales and venture activity. The information stored may be of many different types, but desirably includes that pertinent to the potential of the proposed customer for particular types of economic activity in a particular business area. FIG. 6 is a block diagram of a simplified logical model of a deal shaping tool according to the present invention. A deal shaper computer program 60 resides on a computer (not shown) and a user is prompted to answer one or more questionnaire pages 61 dealing with the proposal. In responding to the questionnaire pages, the user accesses databases that are available, including those databases that are concerned with client information 62, as well as those available from the proposer's databases 63. The deal-shaper tool then evaluates the deal according to the input it receives, and outputs search results 64. In one embodiment, the tool also outputs comparison reports 65 to help evaluate several deals simultaneously. The search results are then considered and the proposal may be re-structured or re-shaped if necessary, for the most attractive deal. The end results may then be reported to management 66.

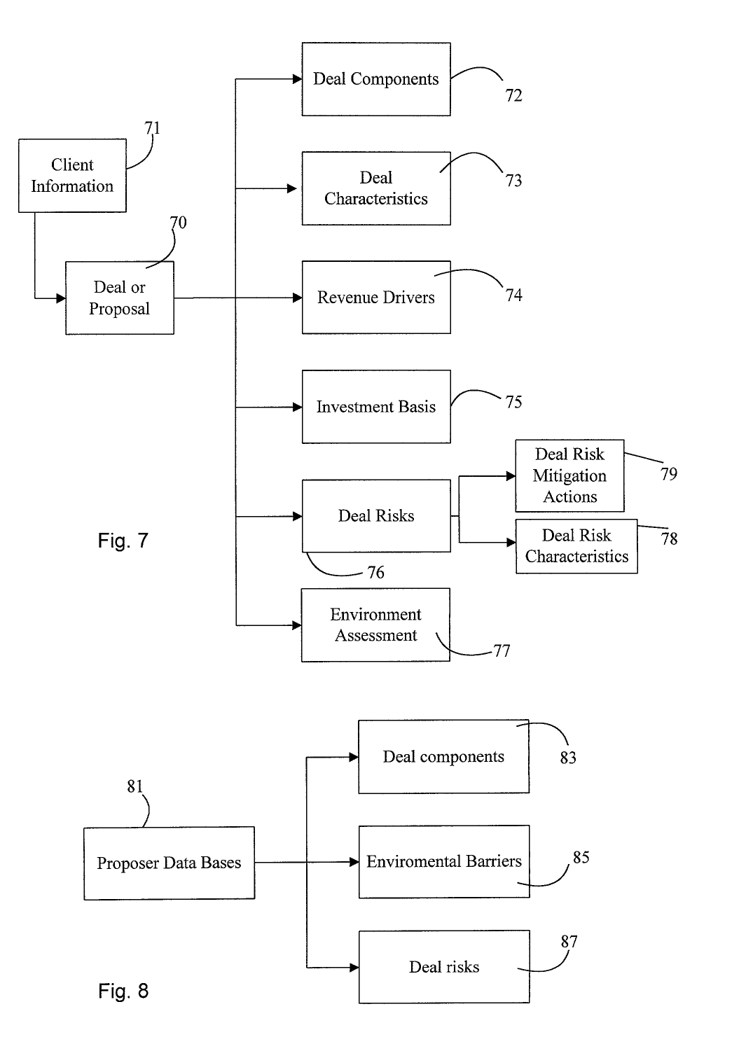

FIG. 7 depicts some of the inputs to the deal or proposal 70 from a potential client or customer that may arise from a database of the client or customer 71. The elements may include some of those discussed above, and desirably include elements that allow a complete picture of the proposal and its effect on the client. These may include, but are not limited to, deal components 72 as discussed above, deal characteristics 73, revenue drivers 74, the investment basis 75, the risks of the deal 76, and any environment assessment 77. In a preferred embodiment, the risks of the deal are accompanied by details of their characteristics 78, as well as ideas or ways to mitigate 79 those risks. While FIG. 7 depicts this information as residing in a client database, the invention is not limited to information held by a client. “Client database” encompasses information gathered that concerns a client or customer, or information shared by the client or customer, so long as it is useful in dealing with the client or structuring proposals or deals with the client. The information may well reside elsewhere, such as in a database of the entity proposing a deal or offering a service.

From the point of view of the proposer, the proposer's database 81 in FIG. 8 should include, but is not limited to, the proposer's deal components 83, which should include the proposer's history and institutional memory of at least all deals of that type and with the particular customer. Also included should be environmental factors 85, as discussed above, which could bear on the situation and affect such things as the viability, timeliness or profitability of the proposal. Deal risks 87 are desirably included in any such assessment.

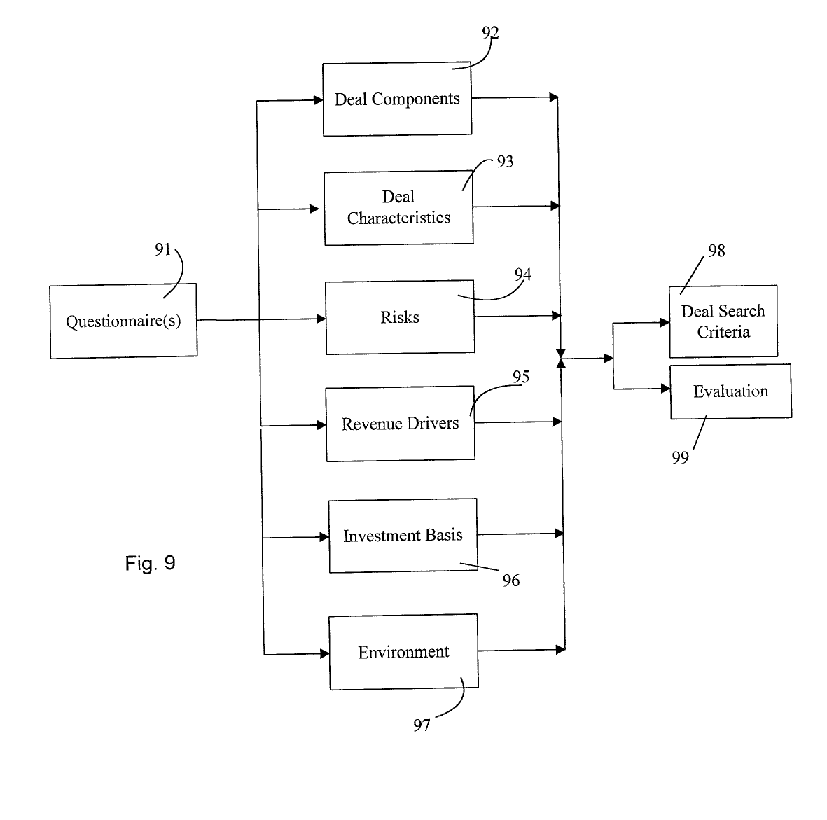

The deal questionnaire pages are shown in more detail in FIG. 9. The questionnaire pages 91 will desirably query the user for components of the deal 92, characteristics of the deal 93, risks of the deal 94, revenue drivers for the deal 95, the proposed investment basis 96 for the deal, and details of the business environment 97. There may desirably also be a query concerning search criteria for the deal 98. It will be understood by those skilled in business that other questions may well be asked and other information evaluated in structuring and evaluating a business deal. Information that deals with specific details of a business proposal, and methods of using that information in a computerized system, are within the scope of the invention. In one embodiment, once the user has entered the necessary information, and a computer has completed its evaluation, the computer will output the data of a completed evaluation 99. In other embodiments, the computerized search is performed in such a manner as to enable a user to evaluate the results.

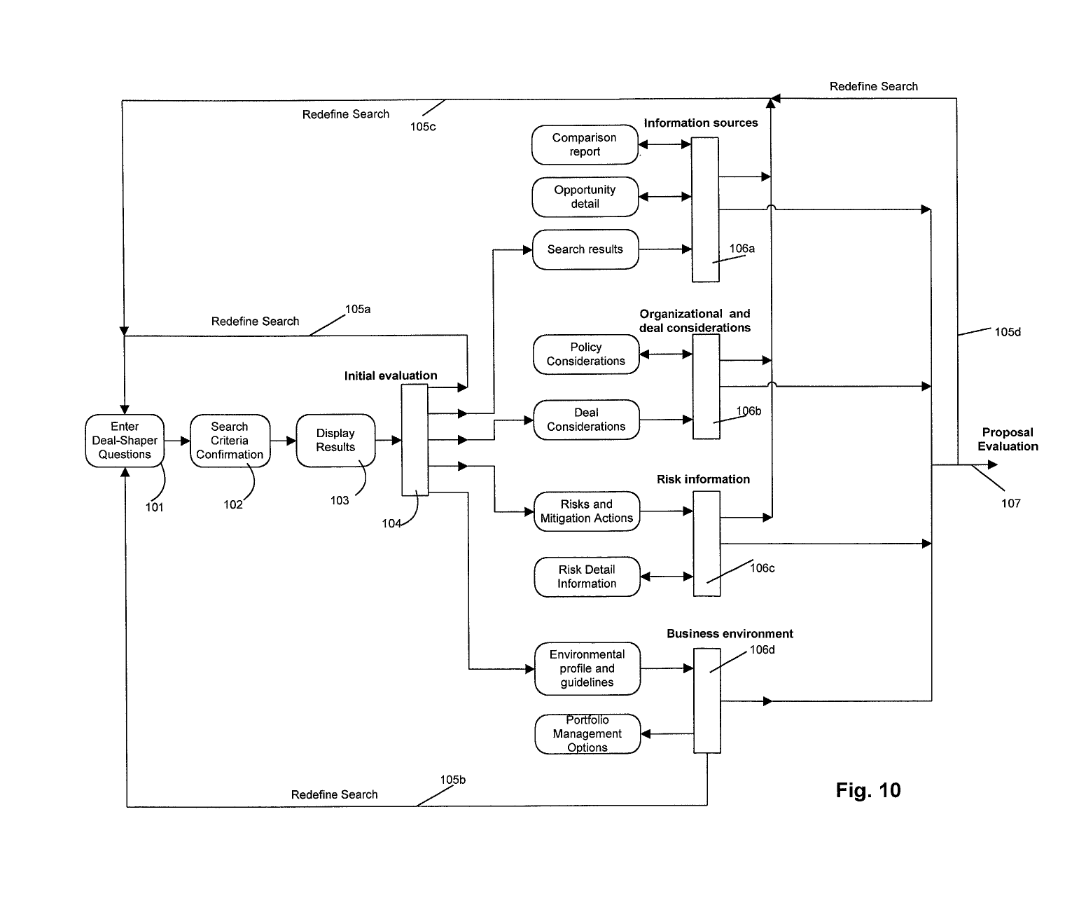

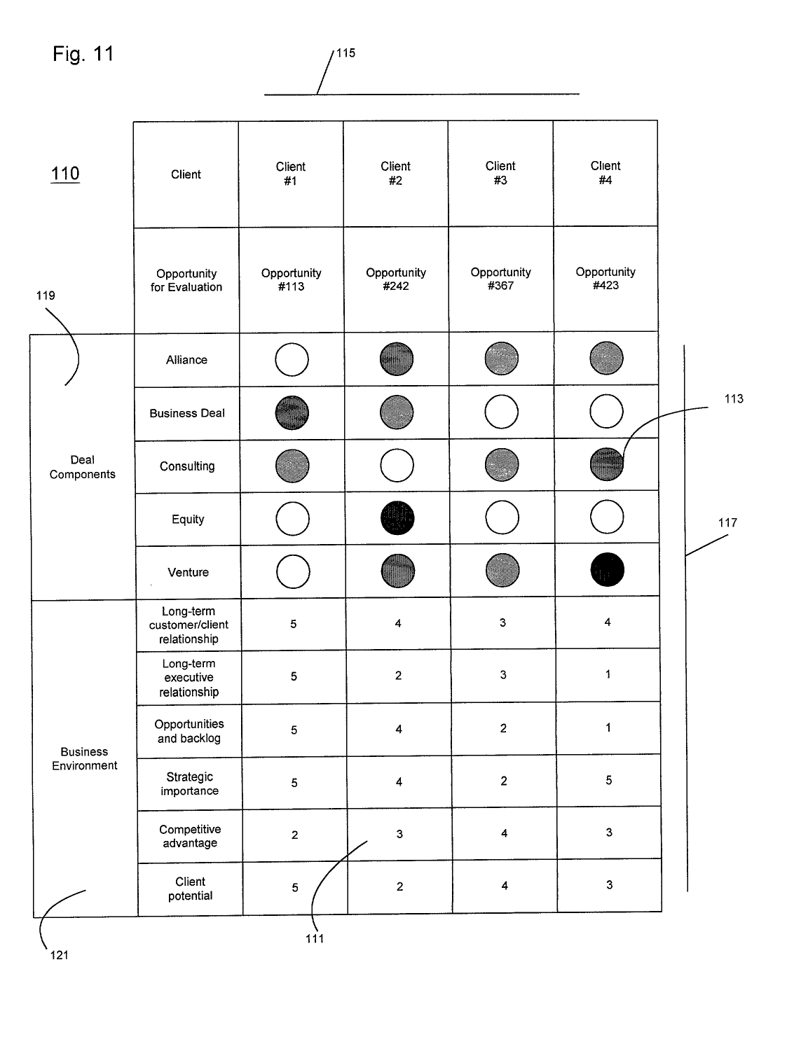

One evaluation of a deal does not end the utility of at least one embodiment. FIG. 10 depicts an iterative process of using this proposal evaluator. An early step in the process calls for entering 101 deal shaper questions, which questions may be in the form of a template. Once these questions have been answered, some further basic questions concerning the type of search and the criteria may be entered 102. After a first search, a computer program then displays 103 the results, and a user makes an initial evaluation 104 and may take action. The actions, depicted in the figure as several flow paths, may include redefining the search 105a, for more accurate or appropriate results.

Other user actions may include those defined by 106a through 106d. 106a describes actions to be taken for comparison with other search reports or results, or further digging for detailed information. A user may look at more deal considerations 106b or to the policies or considerations of his or her employer or organization. If the deal has some negatives, a user may wish to mitigate risks 106c, or to seek more information about the risks. A user may also seek 106d more information concerning the business environment of the particular deal involved. A result of this gathering of more information may be that the search is repeated and refined 105b, 105c, and 105d. Another result may be that the information is used 107 in other computer programs or other business evaluations of the user or the user's employer or organization. If the information is used and evaluated elsewhere, the deal shaper may be re-entered and the search repeated with more refined information.

In one embodiment, a user selects a proposal to evaluate, and considers the risks of the proposal or deal. Elements to be considered are in line with the discussion above. However, rather than writing essays on risk, the user enters a value, either “normal” or “high” for his or her evaluation of a given risk of the proposal in question. Such elements may include, but are not limited to, liability limits of the proposal, the history of partnerships or relationships between the potential partners, any present or past contractual history, the scope of the proposal, and the history of performance of this partner in prior relationships. Other risks may include the business or technical environment of the proposal, the baseline metrics of the situation, including financing, personnel availability, or the need for or lack of any other scarce resource. The factors to be evaluated will depend on the type of proposal contemplated, but risks of late delivery could be present in some types of deals, any potential for great appreciation or depreciation in the value of the enterprise, and any other circumstances judged to be relevant under the circumstances. Again, each of these factors may be considered, and the risk ranked either “high” or “normal”. In one embodiment, risks that are not relevant to a given situation are not considered in that situation.

In order for the deal shaper or proposal evaluator to be of most use, its user interface must be convenient and well-designed. Accordingly, graphical user interfaces provide for familiar and easy-to-use features in one embodiment of the computer system and method used in practicing the invention. For instance, the risk factor mentioned above may be presented in a template with “radio” buttons for selecting “high” or “normal” risk. In other embodiments and for other questions, equally familiar and recognizable features put a user at ease. These features include, but are not limited to, drop-down selector or scroll screens, check boxes, list boxes, windows, and “control-action-response (“CAR”) techniques.

CAR techniques are useful in that the response determines the behavior of the program by detailing the response of the program to each user action on each control of the window. A “control” is anything that a user can activate, click-on or drag to do something in an application window, including radio buttons, scroll choices, or entry fields, which allow for entry of data via a keyboard. Each control requires an action, one or more actions that can be performed, such as double-clicking, single-clicking, entering data, selecting, and so on. A “response” is the action of the computer program to the action of the user. CAR techniques are often used at a high level of programming, but may also be used to govern the response at a detailed level, such as in a deal shaper program.

These techniques and others may be used to require the user to enter data relevant to the deal or proposal to be evaluated. In one embodiment, a template of preselected questions may be formulated with the control techniques mentioned above. The user is then required to enter data, such as by selected from one or more options, or by entering data from the keyboard, or by retrieving data from at least one database. In response to these actions, the computer program then asks more questions or calculates a value pertinent to evaluating a deal.

The environment for a given business deal must also be considered. Even though a particular project may have a higher risk than desired, or a less-than-spectacular return, the environment may dictate that an investment be made or a relationship formed because of the environment. For instance, the person contemplating the deal may wish to acquire experience in a particular field, or may wish to associate with a particular partner in the hope of better future deals. In a similar manner, an otherwise attractive investment or deal may not be suitable because of environmental reasons. Possibilities may include industries of low or stagnant growth, a history of projects that fall through, or other unfavorable predictors. Other environmental factors include, but are not limited to, long term relationships between an organization and a customer or client, long term relationships between executives of organizations, a potential of gaining a future client or business relationship, the strategic importance of the relationship, any backlog of business on one side or the other, any ancillary or related business opportunities, any particular competitive advantage to be gained from the deal or the relationship, and so on.

In one embodiment, the person evaluating the deal assesses at least the more important of these environmental factors. A long-term client relationship may be scored on a one-to-five basis, with one perhaps being appropriate for a new association, and scoring five for a multi-year, multi-project satisfied client or customer. A long-term executive relationship may also be scored on a one-to-five basis, perhaps with one being appropriate for a new association, and five being appropriate for executives that have known each other and dealt with each other for many years, although perhaps not in their present positions. Similar one-to-five scores may be used to assess client potential, a client's competitive position, and any backlog and opportunity record for a particular client. These scores may then be entered and used for further evaluation of the proposal or deal.

Information is very important to the use of this invention. Information useful to business persons may include financial and non-financial data, often available from many public sources. These sources may include private, government, and non-profit and educational institutions. One constant in today's business environment is change, and an increasing rate of change. Therefore, information must be constantly updated in order to stay current with the situation, the market, and the business environment. In one embodiment, the database of useful information is constantly updated. This update may take place in many ways. One way is to browse known sources of information on a periodic basis for updates. Thus, certain databases may be updated on a weekly or daily basis, or even more often, as needed. The Internet provides an easy method for accomplishing this task. Any pertinent updates may then be posted to an existing computer memory or database, and captured for use in evaluating and shaping business proposals.

In another embodiment of the invention, the deal or proposal is assessed based on revenue drivers. This is a way of looking at the proposal in terms of how a return will be generated for one party or for both parties. Revenue generation from the viewpoint of one party may be different for the other party. Consulting revenue for one partner may be viewed as an expense by another partner in the deal. Revenue based on a percentage of sales or volume of sales may be viewed as an incentive by one partner, but an expense by the other. The perception thus depends on the point of view of the person evaluating the deal. Nevertheless, the deal may be evaluated from one viewpoint or from more than one viewpoint, so that the deal most favorable to one party or the other may be pursued.

Alternatively, some deals or proposals may be acquisitions of other companies, or portions thereof, or mergers with other companies, or portions thereof. In one embodiment, a detailed analysis of the assets of the firm or portion thereof to be merged or acquired may be highly important to the success (or failure) of the proposal. While other embodiments have already made clear the importance of future business, or business prospects, of a venture, the asset value, or net present value of a going concern may be the overriding concern in some business proposals. Such a valuation is within the scope of the invention.

One advantage of considering all sources of revenue, and perhaps more than one way of structuring the proposal, lies in the fact that each party, in the long run, should consider the situation of the other party or parties. There will be no chance for a long-term relationship if the deal is profitable for one partner but ruinous for the other. Thus, looking at the proposal under more than one structure may lead to ideas about how to structure the deal so that it may be more favorable to one party or the other. From another viewpoint, these calculations may be used to make the proposal or deal more palatable if the proposer can show the potential customer or client how the deal will favor the customer or client. At a minimum, such calculations may point out to the customer or client a proposed revenue stream, its composition, and how it will arise. A customer may then evaluate the proposal, at least with some idea of how the proposal will benefit the customer.

All sources of revenue should be considered in order to project the most accurate forecast of the proposal. If the partners consider an equity or joint venture type of enterprise, the revenue must arise from sales, and the portions of the partners or shareholders are subject to their ownership situation or to the equity or venture agreement. In an alliance-type situation, revenues may also arise from the agreement, such as in direct revenue, royalties, or from additional sales to one partner or the other as a result of “pull-through” services. Any penalties or incentives should also be considered.

The evaluation of a deal or proposal may then proceed under one or more of several methods. Costs are evaluated, customers are assessed for their potential, and revenue streams are estimated. Rates of return on average assets (ROAA) for the business entity may then be calculated. Alternatively, return on investment (ROI) may be calculated, or return on equity (ROE), after other expenses and interest expense, may be calculated. Other embodiments may calculate an internal rate of return (IRR), or a net present value (NPV) for a business proposal. Depending on the structure of the business, a return for stockholders in terms of dividends along with an estimate of capital appreciation may also be calculated. Alternatively, any revenue streams for the business, for any business partners, for any alliance members, or for vendors to the business, may also be calculated. In one embodiment, a computerized system receives data inputs and performs financial calculations. In other embodiments, a user may perform the calculations and evaluations with or without the aid of a computer.

In another embodiment, the expected or “normal” rates of return are already entered into a computer program, and the results of the above calculation are compared with the expected or “normal” rates. The program then outputs the results to the user. The output may consist of answers to specific questions (IRR, ROI, ROAA, NPV, etc.) If a graphical user interface is preferred, the answers may return in a more user-friendly format. In one embodiment, the program may return answers in a “Harvey-ball” format, similar to that used to evaluate consumer products. Thus a ball with a solid pleasing color (such as blue) may be designated as “excellent” on a particular facet of a deal, while a less-solid color may mean “OK”. Other colors may be used to return less-favorable results or results on deals that would be unacceptable.

Frequently, there is a scale of four or five colors on such a scale, meaning that the Harvey balls could be replaced with numbers. As such, we refer to the Harvey balls as a “pseudo-numerical” scale. Another embodiment uses numbers to return an evaluation, such as a 1-5 scale, wherein “1” would be an unfavorable proposal and “5” would be a highly sought-after deal. Of course, these scales, whether Harvey balls or actual numerals, may be used as well to evaluate inputs through a graphical user interface. In one embodiment, the inputs to a computer are made through such a scale, and outputs are received through such a scale. The computer could of course be programmed with any desired limits on any of the financial tools used to evaluate deals, such as those mentioned above.

FIG. 11 illustrates a graphical user interface 110, in which numerical inputs 111 concern a user's business or environmental assessment, while Harvey-ball outputs 113 concern several components of a deal. The columns 115 contain one column for each customer and deal. The columns list each customer or client and the deal that has been evaluated for the particular client or customer. The rows 117 list information on deal components 119 or the business environment 121. The graphical output may include several ways to structure a deal, as mentioned above, one row for each possible structure, that is, for a business alliance, a business deal such as a merger, an acquisition or an outsourcing, a consulting relationship, an equity relationship, or some form of venture. As mentioned above, in “Harvey-ball” outputs, the color and its intensity signal the user as to the desirability of one aspect of the deal or proposal. An environmental assessment 121 in this embodiment uses numerical inputs from 1 to 5 in each of the rows to assess several aspects of the provider/client relationship. In this embodiment “1” indicates a less-favorable rating, while “5” is the most-favorable rating.

While this invention has been shown and described in connection with the preferred embodiments, it is apparent that certain changes and modifications, in addition to those mentioned above may be made from the basic features of this invention. Many types of organizations besides consultants may benefit from the use of this invention, e.g., any organization wishing to evaluate a business deal or business proposition. In addition, there are many different types of relevant information, and computer software and hardware that may be utilized in practicing the invention, and the invention is not limited to the examples given above. While it is preferable to evaluate a proposition or deal from a variety of viewpoints, and from a variety of calculations, the invention work as well with only a single calculation of a single method of structuring a transaction. Accordingly, it is the intention of the applicants to protect all variations and modifications within the valid scope of the present invention. It is intended that the invention be defined by the following claims, including all equivalents.

We claim:

1. A method of evaluating a business proposal, comprising the steps of:
gathering information on the proposal;
accessing information on similar or analogous proposals; and
evaluating the information by computer.

2. The method of claim 1, wherein information gathered further comprises at least one of revenue elements of the proposal, risks, descriptive information, business issues, business goals, a value of the proposal, methods of achievement of the proposal, and an innovation value of the proposal.

3. The method of claim 1, wherein the information gathering step further comprises answering predetermined questions on at least one template stored in a computer.

4. The method of claim 3, wherein the answers to at least one predetermined question call up at least one more template of predetermined questions, and the computer uses answers to said questions to evaluate the proposal.

5. The method of claim 1, wherein the business proposal is from a service provider to a customer.

6. The method of claim 5, further comprising gathering information on a customer for the proposal, the agents of the customer or employees of the customer.

7. The method of claim 1 wherein information concerning the customer, the customer's experience with the provider, or the provider's experience with other customers is available in a customer relationship repository of information.

8. The method of claim 1 wherein information concerning the experience of the provider in providing the service is available in at least one database.

9. The method of claim 1 wherein information concerning the benefits to the customer is available in at least one database.

10. The method of claim 1, wherein the cost is calculated as a revenue stream to the service provider.

11. The method of claim 1, further comprising the step of calculating a benefit to the customer of providing said service to said customer.

12. The method of claim 1, wherein information gathered for calculation further comprises an assessment of the proposal in light of present business considerations, risks of the proposal, or financial considerations of the proposal.

13. The method of claim 2, wherein at least some of the information is gathered through the Internet, and further comprising the steps of updating the information and recalculating the cost.

14. The method of claim 1, wherein the proposal comprises an offer of a service from the provider, and further comprising the step of calculating a way for the customer to pay for the service.

15. The method of claim 1, wherein the proposal is an alliance, an acquisition, an equity venture, a partnership, an offer for a service, or a venture.

16. The method of claim 1, wherein the input is provided through a graphical user interface, and the input is in a form of brief numerical or pseudo-numerical outputs.

17. The method of claim 1, wherein the output is provided through a graphical user interface, and the output is in a form of brief numerical or pseudo-numerical outputs.

18. A method of evaluating a business proposal, comprising:
searching at least one database for information concerning the customer, the proposal and a business environment;
providing financial data concerning the proposal to a computer;
proposing at least one structure for the business proposal, using said financial information and information from the database; and
calculating an advantage of the business proposal.

19. The method of claim 18, wherein the database comprises a client relationship repository of information.

20. The method of claim 18, wherein the database comprises at least one site on the Internet.

21. The method of claim 18, wherein the step of entering financial data comprises retrieving financial data from at least one database.

22. The method of claim 18, further comprising the step of entering information concerning at least one of risks, descriptive information, business environment, business issues, business goals, a value of the proposal, and methods of achievement of the proposal, for use by a computer in determining an advantage of the proposal.

23. The method of claim 22, wherein the information is entered through at least one template stored in the computer.

24. The method of claim 23, wherein the information entered through at least one template calls up at least one template of predetermined questions, and the computer uses answers to said questions to evaluate the proposal.

25. The method of claim 18, wherein the advantage is calculated as at least one revenue stream.

26. The method of claim 18, wherein the advantage is calculated as at least one revenue stream and includes at least one example of how to pay for the proposal.

27. The method of claim 18, wherein more than one structure is proposed, and further comprising the step of comparing the advantage of each structure.

28. The method of claim 18, wherein the advantage is recalculated by a step of entering updated data into the computer.

29. The method of claim 18, wherein the step of searching comprises a search of at least one Internet site, and further comprising the steps of updating the search periodically, and updating the computer calculation of an advantage periodically.

30. The method of claim 18, wherein the input is provided through a graphical user interface, and the input is in a form of brief numerical or pseudo-numerical outputs.

31. The method of claim 18, wherein the output is provided through a graphical user interface, and the output is in a form of brief numerical or pseudo-numerical outputs.

32. A computer system for evaluating a proposal, comprising:
a computer processor;
at least one memory operably connected to said computer, said memory containing data relevant to the proposal;
a computer program for evaluating the proposal, said program residing in said computer or in said memory, wherein the computer program calculates an output helpful for evaluating the proposal.

33. The computer system of claim 32, wherein the proposal is from a provider of goods or services to a customer.

34. The computer system of claim 32 wherein the data comprises information concerning the proposal, a customer, experience of the provider with the customer, or experience the provider has had with this or other customers.

35. The computer system of claim 32 wherein the computer program further comprises at least one template of predetermined questions, and the computer program uses the answers to said questions to evaluate the proposal.

36. The computer system of claim 32 wherein the answers to at least one predetermined question calls up at least one more template of predetermined questions, and the computer program uses the answers to said questions to evaluate the proposal.

37. The computer system of claim 32 wherein information concerning the customer is available is a customer relationship repository.

38. The computer system of claim 32, wherein the computer program uses a technique of control-action-response in seeking and inputting information from a user of the computer system.
